(19) United States
(12) Patent Application Publication
(10) Pub. No.: US 2018/0139031 A1
(43) Pub. Date: May 17, 2018

(54) DEVICE AND METHOD OF GENERATING SELF-INTERFERENCE CANCELLATION SIGNAL FOR FULL-DUPLEX COMMUNICATION DEVICE

(71) Applicant: Institute For Information Industry, Taipei (TW)

(72) Inventors: Muh WU, Taipei City (TW); Jian-Cheng LI, New Taipei Ciy (TW); Wei-Chih LIN, Taipei City (TW); Shu-Han LIAO, New Taipei City (TW)

(21) Appl. No.: 15/366,949

(22) Filed: Dec. 1, 2016

(30) Foreign Application Priority Data
Nov. 17, 2016 (TW) 105137606

(51) Int. Cl. H04L 5/14; H04L 5/00; H04B 1/10

(52) U.S. Cl. CPC H04L 5/1461; H04B 1/1081; H04L 5/0051

(57) ABSTRACT

The disclosure involves a device and a method of generating a self-interference cancellation signal for a full-duplex communication device. The device is configured to: detect a strength value of a self-interference signal; adjust a strength value of a first reference signal to the strength value of the self-interference signal to generate a second reference signal; adjust the second reference signal according to a predetermined adjustment parameter corresponding to each of a circle of phase angle values respectively to generate a plurality of third reference signals; determine a difference between each of the third reference signals and a receiving signal of the full-duplex communication device including the self-interference signal; and determine one of the third reference signals that corresponds to the smallest of the differences as a self-interference cancellation signal for canceling the self-interference signal.

### PRIORITY

This application claims priority to Taiwan Patent Application No. 105137606 filed on Nov. 17, 2016, which is hereby incorporated by reference in its entirety.

### FIELD

The present invention relates to a device and a method of generating a self-interference cancellation signal. More particularly, the present invention relates to a device and a method of generating a self-interference cancellation signal for a full-duplex communication device.

### BACKGROUND

In order to improve the transmission efficiency under the conventional wireless communication architecture, wireless communication devices often adopt the time-division multiplexing (TDM) technology (i.e., the technology of transmitting signals and receiving signals at different times) or the frequency-division multiplexing (FDM) technology (i.e., the technology of transmitting signals and receiving signals on different frequency bands). However, as requirements proposed by people on the transmission efficiency are increasing sharply, the TDM technology and the FDM technology can no longer satisfy those requirements.

Over recent years, a technology named as co-time co-frequency full-duplex (CCFD) or called as full-duplex for short has gradually gained attention. The full-duplex technology allows a wireless communication device to transmit signals and receive signals at the same time and the same frequency on a single physical channel, thereby improving the transmission efficiency and the utilization ratio of spectrums. However, the full-duplex technology has the problem of self-interference that exists between a signal transmitted by the wireless communication device and a signal received by the wireless communication device, especially the interference to the received signal of a relatively small signal strength caused by the transmitted signal of a relatively large signal strength. To solve the aforesaid self-interference problem, the conventional full-duplex technology usually cancels or suppresses undesired self-interference signals in combination with the antenna isolation technology, the analog interference cancellation technology, the digital interference cancellation technology or the like.

The analog interference cancellation technology is a kind of interference cancellation technology that cancels the self-interference signal with an analog signal, and it cancels the self-interference signal by generating a self-interference cancellation signal of which the strength value and the phase angle value are the same as or similar to these of the self-interference signal. The conventional analog interference cancellation technology generally uses an analog filter to generate a self-interference cancellation signal, and utilizes various iteration algorithms (e.g., the least squares method) to repeatedly estimate the coefficient of the analog filter, thereby generating a self-interference cancellation signal that ideally is completely the same as the self-interference signal (both in the strength and the phase angle). However, this process requires a lot of complicated computation. Furthermore, the conventional analog interference cancellation technology additionally adopts elements of high computation complexity (e.g., a Fourier converter, an analog-to-digital converter or the like) to covert the self-interference signal from radio frequency to base frequency so as to make it convenient to estimate the phase angle value of the self-interference signal, and this process also requires a lot of complicated calculation.

Being limited by a lot of complicated computation requirements, the conventional analog interference cancellation technology often has problems that the implementation thereof is hard, and the cost is high or the like. Accordingly, an objective in the art is to reduce the computation amount and the computation complexity of the conventional analog interference cancellation technology.

### SUMMARY

To achieve the aforesaid objective, one aspect of the present invention may be a device of generating a self-interference cancellation signal for a full-duplex communication device. The device of generating a self-interference cancellation signal may comprise a strength detector, a strength adjuster, a phase angle adjuster and a signal determiner. The strength detector may be configured to detect a strength value of a self-interference signal, and wherein the self-interference signal is from a transmitting signal of the full-duplex communication device. The strength adjuster may be configured to adjust a strength value of a first reference signal into the strength value of the self-interference signal to generate a second reference signal. The phase angle adjuster may be configured to adjust the second reference signal according to a predetermined adjustment parameter corresponding to each of a circle of phase angle values respectively to generate a plurality of third reference signals. The signal determiner may be configured to determine a difference between each of the third reference signals and a receiving signal of the full-duplex communication device, and determine one of the third reference signals that corresponds to the smallest of the differences as a self-interference cancellation signal for canceling the self-interference signal, and wherein the receiving signal comprises the self-interference signal.

To achieve the aforesaid objective, one aspect of the present invention may be a method of generating a self-interference cancellation signal for a full-duplex communication device. The method of generating a self-interference cancellation signal may comprise the following steps of: detecting by a strength detector a strength value of a self-interference signal, the self-interference signal being from a transmitting signal of the full-duplex communication device; adjusting by a strength adjuster a strength value of a first reference signal into the strength value of the self-interference signal to generate a second reference signal; adjusting by a phase angle adjuster the second reference signal according to a predetermined adjustment parameter corresponding to each of a circle of phase angle values respectively to generate a plurality of third reference signals; determining by a signal determiner a difference between each of the third reference signals and a receiving signal of the full-duplex communication device, the receiving signal comprising the self-interference signal; and determining by the signal determiner one of the third reference signals that corresponds to the smallest of the differences as a self-interference cancellation signal for canceling the self-interference signal.

Different from the conventional analog interference cancellation technology, the present invention neither needs to use the iteration algorithms nor needs to convert the self-interference signal from the radio frequency to the base frequency during the process of generating the self-interference cancellation signal. Therefore, the present invention can effectively reduce the computation amount and the computation complexity of the conventional analog interference cancellation technology.

What described above presents a summary of the present invention (including the problem to be solved, the means to solve the problem and the effect of the present invention) to provide a basic understanding of the present invention. However, this is not intended to encompass all aspects of the present invention. Additionally, what described above is neither intended to identify key or essential elements of the present invention, nor intended to define the scope of the present invention. This summary is provided only to present basic concepts of the present invention in a simple form and as an introduction to the following

### DETAILED DESCRIPTION

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an exemplary structure of a transceiver of a full-duplex communication device in one or more embodiments of the present invention;

FIG. 2 illustrates an exemplary structure of a device of generating a self-interference cancellation signal shown in FIG. 1 in one or more embodiments of the present invention;

FIG. 3 illustrates an exemplary representation of a first reference signal and a self-interference signal shown in FIG. 2 on polar coordinates in one or more embodiments of the present invention;

FIG. 4 illustrates an exemplary structure of a phase angle adjuster shown in FIG. 2 in one or more embodiments of the present invention; and

FIG. 5 illustrates a method of generating a self-interference cancellation signal for a full-duplex communication device in one or more embodiments of the present invention.

### DETAILED DESCRIPTION

In the following description, the present invention will be explained with reference to embodiments thereof. However, these embodiments of the present invention are not intended to limit the present invention to any environment, applications, structures, processes or steps described in these embodiments. In the attached drawings, elements unrelated to the present invention are omitted from depiction; and dimensional relationships among individual elements in the attached drawings are illustrated only for ease of understanding, but not to limit the actual scale. Unless stated particularly, same (or similar) element labels correspond to same (or similar) elements in the following description.

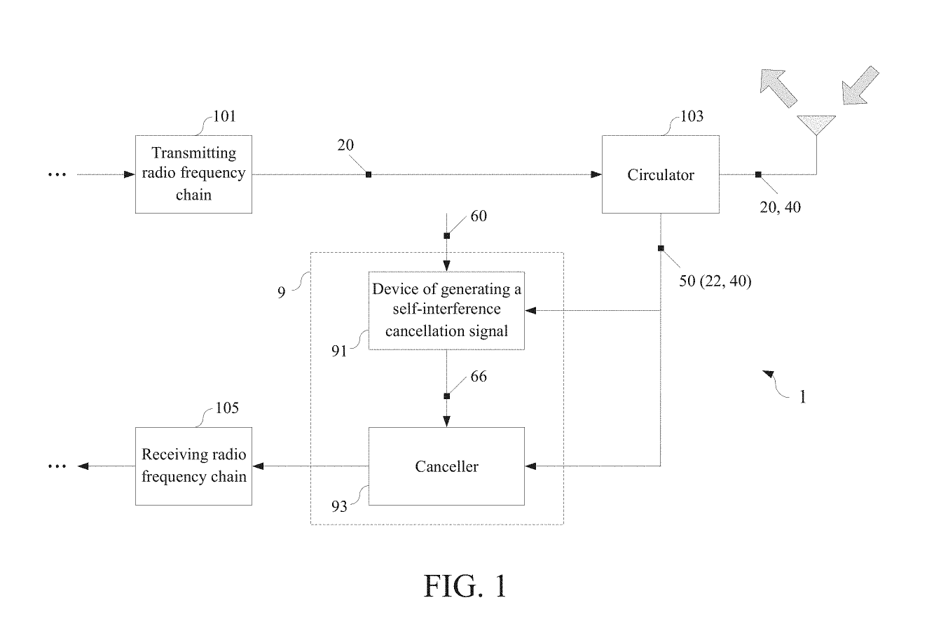

FIG. 1 illustrates an exemplary structure of a transceiver of a full-duplex communication device in one or more embodiments of the present invention. However, this structure is not intended to limit the present invention. Referring to FIG. 1, a transceiver 1 of a full-duplex communication device may comprise a transmitting radio frequency chain 101, a circulator 103, a receiving radio frequency chain 105 and an analog self-interference cancellation device 9 among other communication modules. The transmitting radio frequency chain 101 may transmit a transmitting signal 20 to an antenna via the circulator 103, and then the antenna radiates the transmitting signal 20. The antenna may receive an external signal 40 at the same time, and the receiving radio frequency chain 105 may receive the external signal 40 from the antenna via the circulator 103. Since the transceiver 1 can transmit the transmitting signal 20 and receive the external signal 40 at the same time and the same frequency on a single physical channel under the full-duplex architecture, the receiving radio frequency chain 105 may further receive a self-interference signal 22 derived from the transmitting signal 20 in addition to the external signal 40.

In some embodiments, a receiving signal 50 received by the receiving radio frequency chain 105 may comprise the external signal 40 and the self-interference signal 22. In some embodiments where no external signal 40 exists (e.g., at the ex-factory test stage), the receiving signal 50 received by the receiving radio frequency chain 105 may only comprise the self-interference signal 22. In some embodiments, the external signal 40 may only comprise signals transmitted from other wireless communication devices (under an ideal situation). In some embodiments, in addition to the signals transmitted from other wireless communication devices, the external signal 40 may further comprise various noises and external interferences (under a non-ideal situation).

In some embodiments, the transceiver 1 may not comprise the circulator 103. Instead, the transceiver 1 may comprise at least one first antenna (i.e., one or more first antennas) and at least one second antenna (i.e., one or more second antennas), and wherein the at least one first antenna is directly connected to the transmitting radio frequency chain 101, and the at least one second antenna is directly connected to the receiving radio frequency chain 105. The transmitting radio frequency chain 101 may radiate the transmitting signal 20 via the at least one first antenna, and the receiving radio frequency chain 105 may receive the external signal 40 via the at least one second antenna. Under the full-duplex architecture, the receiving radio frequency chain 105 further receives at least a part of the transmitting signal 20 radiated by the at least one first antenna (i.e., the self-interference signal 22) from the at least one second antenna in addition to the external signal 40 received from the at least one second antenna.

The analog self-interference cancellation device 9 may comprise a device 91 of generating a self-interference cancellation signal and a canceller 93. The device 91 of generating a self-interference cancellation signal may be configured to generate a self-interference cancellation signal 66, and the canceller 93 may use the self-interference cancellation signal 66 to cancel the self-interference signal 22 in the receiving signal 50. In some embodiments, the canceller 93 may comprise an adder having two input terminals and an output terminal and an inverter, the receiving signal 50 may be inputted into one of the two input terminals, and the self-interference cancellation signal 66 may have the phase thereof inverted by the inverter and then is inputted into the other one of the two input terminals. In some embodiments, the canceller 93 may comprise a subtracter having two input terminals and an output terminal, the receiving signal 50 may be inputted into one of the two input terminals, and the self-interference cancellation signal 66 may be inputted into the other one of the two input terminals. In either way, when the strength value and the phase angle value of the self-interference cancellation signal 66 are respectively the same as or similar to the strength value and the phase angle value of the self-interference signal 22, the canceller 93 can effectively cancel the self-interference signal 22 in the receiving signal 50.

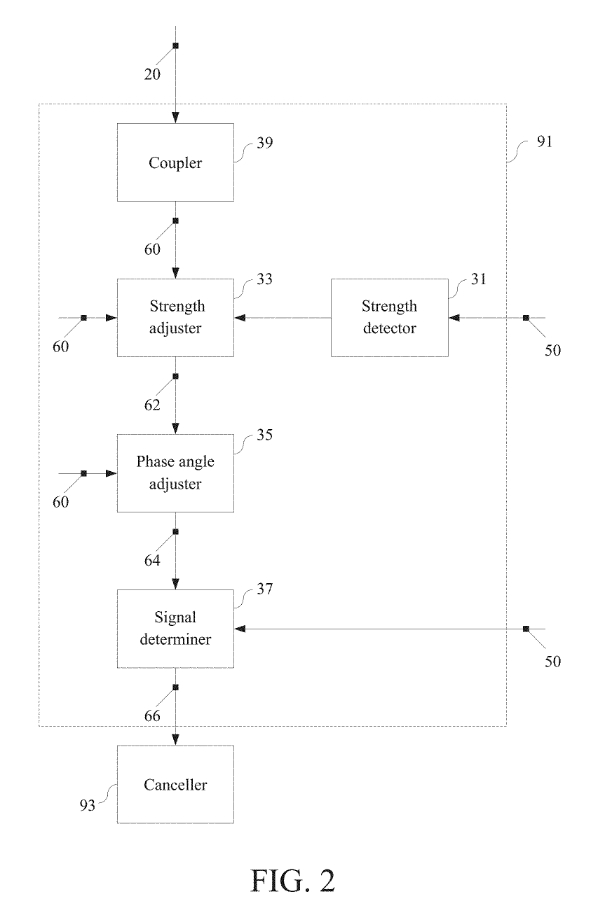

FIG. 2 illustrates an exemplary structure of the device 91 of generating a self-interference cancellation signal shown in FIG. 1 in one or more embodiments of the present invention. However, this structure is not intended to limit the present invention. Referring to FIG. 2, in some embodiments, the device 91 of generating a self-interference cancellation signal may comprise a strength detector 31, a strength adjuster 33, a phase angle adjuster 35 and a signal determiner 37. In some embodiments, the device 91 of generating a self-interference cancellation signal may further comprise a coupler 39 in addition to the strength detector 31, the strength adjuster 33, the phase angle adjuster 35 and the signal determiner 37. The strength detector 31, the strength adjuster 33, the phase angle adjuster 35 and the signal determiner 37 and the coupler 39 may be electrically connected via other elements (i.e., indirectly electrical connection). Alternatively, the strength detector 31, the strength adjuster 33, the phase angle adjuster 35 and the signal determiner 37 and the coupler 39 may be electrically connected without using other elements (i.e., directly electrical connection). Through the directly or indirectly electrical connection, signals can be transmitted between the strength detector 31, the strength adjuster 33, the phase angle adjuster 35 and the signal determiner 37 and the coupler 39 for data communication.

The strength detector 31 may be configured to detect a strength value of the self-interference signal 22 from the receiving signal 50. In some embodiments, the strength detector 31 may comprise a signal strength detection circuit, and the signal strength detection circuit may comprise a detection element and a conversion element. The detection element may be configured to detect signal characteristics (e.g., the thermal energy, the magnetic energy, the electric energy or the like) of the self-interference signal 22, and the conversion element may convert the detected characteristics into particular parameters (e.g., the power value, the voltage value, the current value or the like) as the strength value of the self-interference signal 22. The strength detector 31 may comprise various types of signal strength detection circuits, e.g., a power detection circuit, without departing from the spirit of the present invention. The power value will be taken as an example of the strength value of the self-interference signal 22 for illustration hereinafter. However, this example is not intended to limit the present invention.

In some embodiments, the device 91 of generating a self-interference cancellation signal may first adjust a strength value of a first reference signal 60, and then adjust a phase angle value of the first reference signal 60. For example, the strength adjuster 33 may be configured to adjust the strength value of the first reference signal 60 to be the same as the strength value of the self-interference signal 22 so as to generate a second reference signal 62. In some embodiments, the strength adjuster 33 may comprise a signal strength adjustment circuit, and the signal strength adjustment circuit comprises a gain element and an attenuation element to enhance or attenuate the strength value of the first reference signal 60. When the strength value (e.g., the power value) of the first reference signal 60 is smaller than the strength value (e.g., the power value) of the self-interference signal 22, the gain element may be configured to enhance the strength value of the first reference signal 60 to be the same as the strength value of the self-interference signal 22. When the strength value of the first reference signal 60 is larger than the strength value of the self-interference signal 22, the attenuation element may be configured to attenuate the strength value of the first reference signal 60 to be the same as the strength value of the self-interference signal 22. The strength adjuster 33 may comprise various types of signal strength adjustment circuits without departing from the spirit of the present invention.

The first reference signal 60 may be a signal that is the same as or associated with the transmitting signal 20. In some embodiments, e.g., in cases where the device 91 of generating a self-interference cancellation signal comprises the coupler 39, the first reference signal 60 may be the signal coupled from the transmitting signal 20 via the coupler 39. In some embodiments, e.g., in cases where the device 91 of generating a self-interference cancellation signal does not comprise the coupler 39, the first reference signal 60 may be a signal generated by the device 91 of generating a self-interference cancellation signal itself according to the transmitting signal 20.

After the second reference signal 62 is generated, the phase angle adjuster 35 may be configured to adjust the second reference signal 62 according to a predetermined adjustment parameter corresponding to each of a circle of phase angle values respectively to generate a plurality of third reference signals 64. In some embodiments, the phase angle adjuster 35 may comprise a signal phase angle adjustment circuit that is configured to adjust the phase angle value of the second reference signal 62 into each phase angle value of the circle of phase angle values respectively. In other words, each of the third reference signals 64 is just the signal representation of the second reference signal 62 after being adjusted into a phase angle value of the circle of phase angle values. The phase angle adjuster 35 may comprise various types of signal phase angle adjustment circuits without departing from the spirit of the present invention.

After the third reference signals 64 are generated, the signal determiner 37 may be configured to determine a difference between each of the third reference signals 64 and the receiving signal 50, and determine one of the third reference signals 64 that corresponds to the smallest of the differences as a self-interference cancellation signal 66 for canceling the self-interference signal 22. In some embodiments, like the canceller 93, the signal determiner 37 may comprise an adder having two input terminals and an output terminal and an inverter, the receiving signal 50 may be inputted into one of the two input terminals, and each of the third reference signals 64 may have the phase thereof inverted by the inverter and then is inputted into the other one of the two input terminals. In some embodiments, like the canceller 93, the signal determiner 37 may comprise a subtracter having two input terminals and an output terminal, the receiving signal 50 may be inputted into one of the two input terminals, and each of the third reference signals 64 may be inputted into the other one of the two input terminals. In some embodiments, the signal determiner 37 may be integrated with the canceller 93 into a same unit, i.e., the signal determiner 37 may be replaced by the canceller 93 to perform the above operations.

In some embodiments, the device 91 of generating a self-interference cancellation signal may first adjust a phase value of the first reference signal 60, and then adjust a strength value of the first reference signal 60. For example, the phase angle adjuster 35 may be configured to adjust the first reference signal 60 according to a predetermined adjustment parameter corresponding to each of the circle of phase angle values respectively to generate a plurality of fourth reference signals (i.e., reference signals of which the strength values are different and the phase angles correspond to a circle of phase angle values respectively). Additionally, the strength adjuster 33 may be configured to adjust a strength value of each of the fourth reference signals to be the same as the strength value of the self-interference signal 22 so as to generate a plurality of fifth reference signals (i.e., reference signals of which the strength values are the same and the phase angles correspond to the circle of phase angle values respectively). The signal determiner 37 may be configured to determine a difference between each of the fifth reference signals and the receiving signal 50, and determine one of the fifth reference signals that corresponds to the smallest of the differences as the self-interference cancellation signal 66 for canceling the self-interference signal 22.

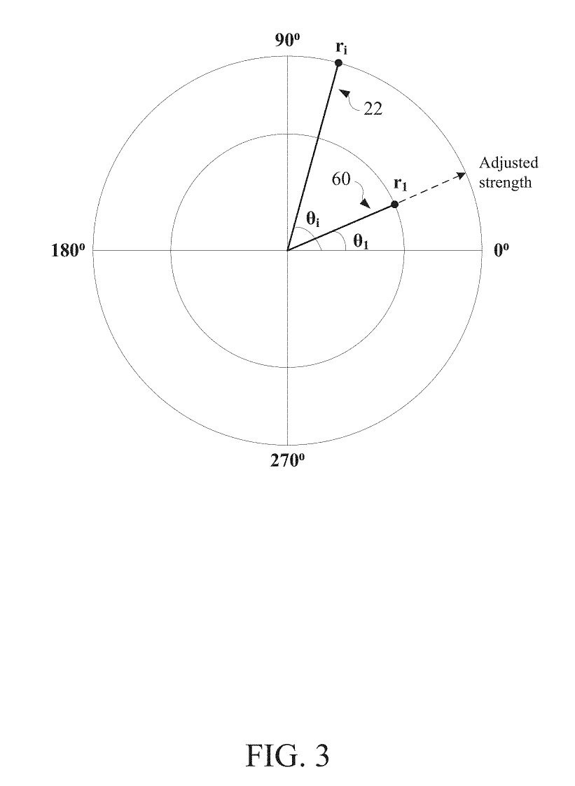

Operations of the strength adjuster 33, the phase angle adjuster 35 and the signal determiner 37 will be described hereinafter by taking FIG. 3 as an exemplary example. However, this exemplary example is not intended to limit the present invention. FIG. 3 illustrates an exemplary representation of the first reference signal 60 and the self-interference signal 22 shown in FIG. 2 on polar coordinates in one or more embodiments of the present invention. Referring to FIG. 3, if a strength value rᵢ of the self-interference signal 22 is greater than a strength value r₁ of the first reference signal 60, then the strength adjuster 33 will first adjusts the strength value r₁ of the first reference signal 60 to be the same as the strength value rᵢ of the self-interference signal 22 to generate the second reference signal 62. Then, the phase angle adjuster 35 may change a phase angle value θ₁ of the second reference signal 62 to generate a plurality of third reference signals 64. In other words, through the operation of the strength adjuster 33, the second reference signal 62 and the self-interference signal 22 may be equivalent to two points on the circumference of a circle formed with a same radius (i.e., with the strength value rᵢ as the radius). Furthermore, the phase angle adjuster 35 is used to calculate all points on the circumference (i.e., the third reference signals 64) and determine the predetermined adjustment parameter corresponding to each of the points, and the signal determiner 37 is used to determine a phase angle when the two points are overlapped with or close to each other.

Because the second reference signal 62 and the self-interference signal 22 have the same strength value (i.e., the strength value rᵢ), a difference between the second reference signal 62 and the self-interference signal 22 will gradually decrease as the phase angle θ₁ of the second reference signal 62 approaches the phase angle θᵢ of the self-interference signal 22. In other words, the signal determiner 37 may determine a difference between each of the third reference signals 64 and the receiving signal 50 comprising the self-interference signal 22, and determine one of the third reference signals 64 that corresponds to the smallest of the differences as the self-interference cancellation signal 66 for canceling the self-interference signal 22.

In some embodiments, the phase angle adjuster 35 may adjust the second reference signal 62 based on a sequence searching method, and the signal determiner 37 may determine the difference between each of the third reference signals 64 and the receiving signal 50 comprising the self-interference signal 22 based on the sequence searching method. For example, the phase angle adjuster 35 may adjust the second reference signal 62 sequentially according to a predetermined phase angel value interval, and every time the phase angle adjuster 35 generates a third reference signal 64, the signal determiner 37 determines a difference between the third reference signal 64 and the receiving signal 50 comprising the self-interference signal 22 until the signal determiner 37 determines one of the third reference signals 64 that corresponds to the smallest of the differences as the self-interference cancellation signal 66. The predetermined phase angle value interval may be for example but not limited to: 0.1 degree, 0.2 degree, 1 degree, 5 degree, 10 degree or the like.

In some embodiments, the phase angle adjuster 35 may adjust the second reference signal 62 based on a binary searching method, and the signal determiner 37 may determine the difference between each of the third reference signals 64 and the receiving signal 50 comprising the self-interference signal 22 based on the binary searching method. In detail, the phase angle adjuster 35 will first select a median of a circle of phase angle values to adjust the second reference signal 62 so as to generate a third reference signal 64, and the signal determiner 37 determines a difference between the third reference signal 64 and the receiving signal 50 comprising the self-interference signal 22. According to the difference, the phase angle adjuster 35 will select a half of the circle of phase angle values, and adjust the second reference signal 62 according to a median of the half of the circle of phase angle values so as to generate another third reference signal 64, and the signal determiner 37 will determine a difference between the another third reference signal 64 and the receiving signal 50 comprising the self-interference signal 22. The phase angle adjuster 35 and the signal determiner 37 will repeat the above operations until the signal determiner 37 determines one of the third reference signals 64 that corresponds to the smallest of the differences as the self-interference cancellation signal 66.

In some embodiments, the phase angle adjuster 35 may adjust the second reference signal 62 based on a sequence searching method and a binary searching method, and the signal determiner 37 may determine the difference between each of the third reference signals 64 and the receiving signal 50 comprising the self-interference signal 22 based on the sequence searching method and the binary searching method. In those embodiments, the sequence searching method may be used before the use of the binary searching method, or the binary searching method may be used before the use of the sequence searching method.

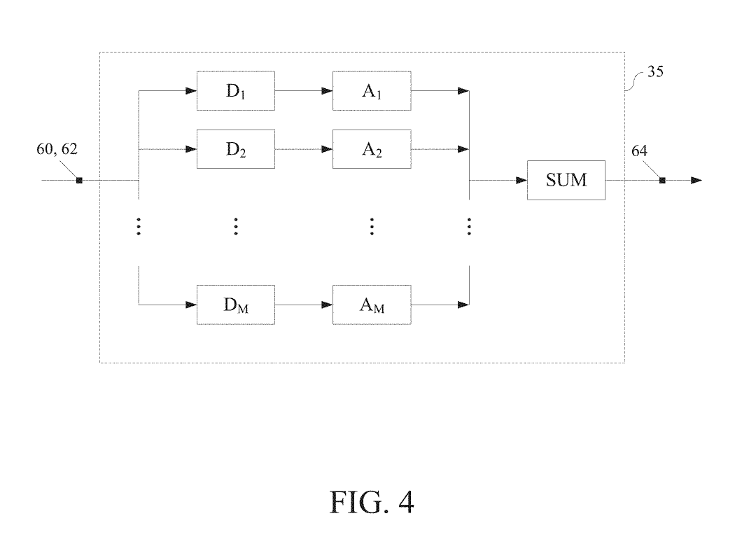

FIG. 4 illustrates an exemplary structure of the phase angle adjuster 35 shown in FIG. 2 in one or more embodiments of the present invention. However, this structure is not intended to limit the present invention. Referring to FIG. 4, in some embodiments, the phase angle adjuster 35 may comprise a multi-path adjustment circuit, the multi-path adjustment circuit may comprise multiple paths each of which comprises a delay element (i.e., delay elements D₁, D₂, . . . , D_{M}) and an attenuation/gain element (i.e., attenuation/gain elements A₁, A₂, . . . , A_{M}), and wherein M is an integer greater than 2. One end of the paths may be configured to receive an input signal, and the other end of the paths is connected to an end of a summator SUM, and the other end of the summator SUM may be configured to output an output signal. In other words, the phase angle value of the input signal can be changed by the multi-path adjustment circuit to generate the output signal.

Before the strength adjuster 33 adjusts the first reference signal 60, the phase angle adjuster 35 may first determine a circle of phase angle values and a plurality of predetermined adjustment parameters corresponding to the circle of phase angle values by controlling the delay elements D₁, D₂, . . . , D_{M} and the attenuation/gain elements A₁, A₂, . . . , A_{M}. The phase angle interval in the circle of phase angle values may be adjusted depending on different requirements, and the number of the circle of phase angle values changes in response to different phase angle intervals. For example, when the phase angle interval is respectively 0.1 degree, 0.2 degree, 1 degree, 5 degree and 10 degree, the number of the circle of phase angle values is respectively 3600, 1800, 360, 72 and 36. In principle, the smaller the phase angle interval is, the more the paths required will be.

In some embodiments, the delay elements D₁, D₂, . . . , D_{M} may be assigned with fixed but different delay amounts respectively (i.e., each path only has a first-order delay amount) so that the first reference signal 60 generates different delays on different paths, and this is equivalent to projecting the first reference signal 60 on different phase angle axes. Taking the four-path adjustment circuit as an example, the first reference signal 60 may be projected on phase angle axes of 0 degree, 90 degree, 180 degree and 270 degree respectively via the delay elements D₁, D₂, D₃ and D₄. In those embodiments, each of the attenuation/gain elements A₁, A₂, . . . , A_{M} may be assigned with an adjustable attenuation/gain amount (i.e., each path may have a multi-order attenuation/gain amount) so that the first reference signal 60 generates attenuation/gain on different paths, and this is equivalent to determining a location of the first reference signal 60 on each phase angle axis from the origin. The path of a larger attenuation amount (a smaller gain amount) represents that the first reference signal 60 will be projected on a point closer to the origin on the phase angle axis corresponding to the path. From the perspective of the polar coordinates, the first reference signal 60 passing through each path may be equivalent to a vector from the origin to a point on a certain phase angle axis.

The summator SUM may calculate a sum of a plurality of first reference signals 60 after being adjusted by all the paths, and this is equivalent to calculating a sum of all vectors generated by all the paths. Because the attenuation/gain amount of the attenuation/gain elements A₁, A₂, . . . , A_{M} is adjustable, more vectors can be generated on the polar coordinates by using the vector combination. For example, a vector on the 0-degree phase angle axis at 1 unit length from the origin and a vector on the 90-degree phase angle axis at 1 unit length from the origin can be combined into a vector on the 45-degree phase angle axis at \sqrt{2} unit length from the origin. After considering all vector combinations generated by the multi-order attenuation/gain amount of the multiple paths, a circle of phase angle values and predetermined adjustment parameters corresponding to the circle of phase angle values can be determined from the vectors (i.e., all points on the circumference of a circle that is drew with a fixed radius are determined in the distribution space of the vectors), and wherein each of the predetermined adjustment parameters is equivalent to the delay amount of one of the delay elements D₁, D₂, . . . , D_{M} and the attenuation/gain amount of one of the attenuation/gain elements A₁, A₂, . . . , A_{M} that correspond to a certain point on the circumference. After determining the circle of phase angle values and the predetermined adjustment parameters corresponding to the circle of phase angle values, a storage may be used to store the circle of phase angle values and the plurality of predetermined adjustment parameters corresponding to the circle of phase angle values in advance. The storage may be any of various types of memories that use the electric energy, the magnetic energy or the optical energy for storage, e.g., various types of random access memories (RAMs) and read only memories (ROMs) that use the electric energy for storage. In some embodiments, the storage may be disposed inside the device 91 of generating a self-interference cancellation signal. In some embodiments, the storage may be disposed outside the device 91 of generating a self-interference cancellation signal.

After the strength adjuster 33 adjusts the first reference signal 60 into the second reference signal 62, the phase angle adjuster 35 can control the delay elements D₁, D₂, . . . , D_{M} and the attenuation/gain elements A₁, A₂, . . . , A_{M} respectively according to the circle of phase angle values and each of the plurality of predetermined adjustment parameters corresponding to the circle of phase angle values that are stored in the storage in advance. Each of the predetermined adjustment parameters includes controlling the delay amount of the delay elements D₁, D₂, . . . , D_{M} and the attenuation/gain amount of the attenuation/gain elements A₁, A₂, . . . , A_{M}, so each of the predetermined adjustment parameters can be used to shift the phase angle value of the second reference signal 62 to one phase angle value in the circle of phase angle values while maintaining the strength value of the second reference signal 62.

In some embodiments, the phase angle adjuster 35 may comprise a single-path adjustment circuit, and the single-path adjustment circuit may comprise a single delay element and a single attenuation/gain element. On the single path, one end of the single delay element is connected with the single attenuation/gain element, one of the other end of the single delay element and the other end of the single attenuation/gain element is used to receive an input signal (e.g., the first reference signal 60 or the second reference signal 62), and the other one of the other end of the single delay element and the other end of the single attenuation/gain element is used to output an output signal.

Before the strength adjuster 33 adjusts the first reference signal 60, the phase angle adjuster 35 may first determine a circle of phase angle values and a plurality of predetermined adjustment parameters corresponding to the circle of phase angle values by controlling the delay amount of the single delay element and the attenuation/gain amount of the single attenuation/gain element, and use a storage to store the circle of phase angle values and the plurality of predetermined adjustment parameters corresponding to the circle of phase angle values in advance.

After the strength adjuster 33 adjusts the first reference signal 60 into the second reference signal 62, the phase angle adjuster 35 can control the delay amount of the single delay element and the attenuation/gain amount of the single attenuation/gain element respectively according to the circle of phase angle values and each of the plurality of predetermined adjustment parameters corresponding to the circle of phase angle values that are stored in the storage in advance so that a phase angle value of the second reference signal 62 can be shifted to one phase angle value in the circle of phase angle values according to each of the predetermined adjustment parameters while maintaining the strength value of the second reference signal 62.

In some embodiments, the above operations of the analog self-interference cancellation device 9 may be controlled by a computing device comprised in a full-duplex communication device. The computing device may have computing elements such as a processor or a microprocessor for general purposes, and execute various operations via those computing elements. The computing device may have storage elements such as a memory and/or a storage for general purposes, and store various kinds of data via these storage elements. The computing device may have input/output elements for general purposes, and receive data inputted from users and output data to the users via these input/output elements. The computing device can control the analog self-interference cancellation device 9 through elements such as the aforesaid computing elements, storage elements and input/output elements according to a processing procedure constructed by software, firmware, programs, algorithms or the like.

In some embodiments, the analog self-interference cancellation device 9 may be an integrated circuit.

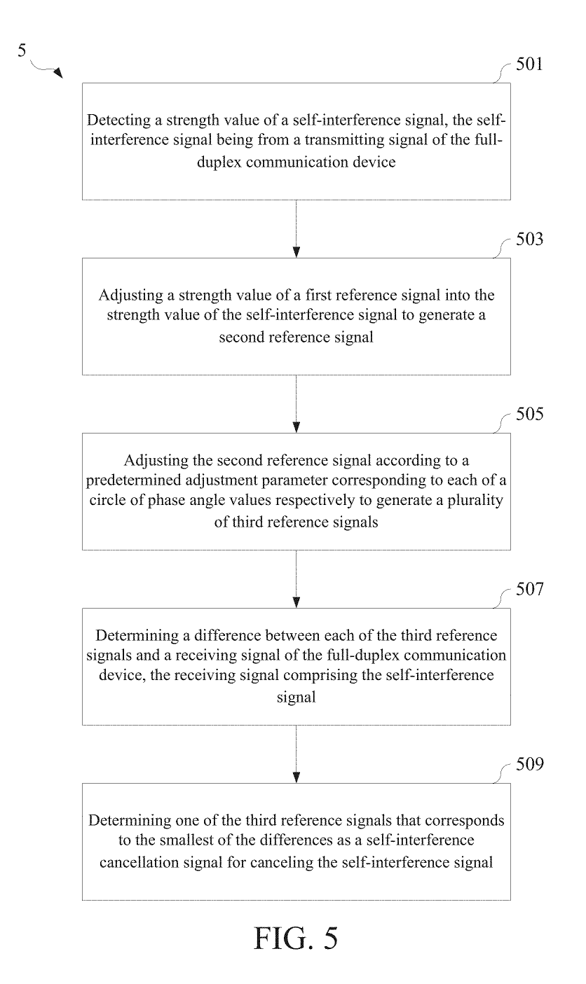

FIG. 5 illustrates a method of generating a self-interference cancellation signal for a full-duplex communication device in one or more embodiments of the present invention. Referring to FIG. 5, a method 5 of generating a self-interference cancellation signal may comprise the following steps of: detecting by a strength detector a strength value of a self-interference signal, the self-interference signal being from a transmitting signal of the full-duplex communication device (labeled as 501); adjusting by a strength adjuster a strength value of a first reference signal into the strength value of the self-interference signal to generate a second reference signal (labeled as 503); adjusting by a phase angle adjuster the second reference signal according to a predetermined adjustment parameter corresponding to each of a circle of phase angle values respectively to generate a plurality of third reference signals (labeled as 505); determining by a signal determiner a difference between each of the third reference signals and a receiving signal of the full-duplex communication device, the receiving signal comprising the self-interference signal (labeled as 507); and determining by the signal determiner one of the third reference signals that corresponds to the smallest of the differences as a self-interference cancellation signal for canceling the self-interference signal (labeled as 509). The order of the aforesaid steps is not intended to limit the present invention. The order of the aforesaid steps can be adjusted without departing from the spirit of the present invention.

In some embodiments, the first reference signal may be a signal coupled from the transmitting signal.

In some embodiments, the phase angle adjuster may adjust the second reference signal according to at least one of a sequence searching method and a binary searching method, and the signal determiner may determine the differences according to at least one of the sequence searching method and the binary searching method.

In some embodiments, the phase angle adjuster may comprise a multi-path adjustment circuit, the multi-path adjustment circuit may comprise multiple paths each of which may comprise a delay element and an attenuation/gain element, and the phase angle adjuster may determine the circle of phase angle values and the predetermined adjustment parameters by controlling the delay elements and the attenuation/gain elements.

In some embodiments, the phase angle adjuster may comprise a multi-path adjustment circuit, the multi-path adjustment circuit may comprise multiple paths each of which may comprise a delay element and an attenuation/gain element, and the phase angle adjuster may determine the circle of phase angle values and the predetermined adjustment parameters by controlling the delay elements and the attenuation/gain elements. Additionally, the phase angle adjuster may control the delay elements and the attenuation/gain elements according to each of the predetermined adjustment parameters respectively to adjust the second reference signal.

In some embodiments, the phase angle adjustor may comprise a single-path adjustment circuit, the single-path adjustment circuit may comprise a delay element and an attenuation/gain element, and the phase angle adjuster may determine the circle of phase angle values and the predetermined adjustment parameters by controlling the single delay element and the single attenuation/gain element.

In some embodiments, the phase angle adjustor may comprise a single-path adjustment circuit, the single-path adjustment circuit may comprise a delay element and an attenuation/gain element, and the phase angle adjuster may determine the circle of phase angle values and the predetermined adjustment parameters by controlling the single delay element and the single attenuation/gain element. Additionally, the phase angle adjuster may control the delay element and the attenuation/gain element according to each of the predetermined adjustment parameters respectively to adjust the second reference signal.

In some embodiments, the method 5 of generating a self-interference cancellation signal may further comprise the following steps of: adjusting by the phase angle adjuster the first reference signal according to the predetermined adjustment parameter corresponding to each of the circle of phase angle values respectively to generate a plurality of fourth reference signals; adjusting by the strength adjuster a strength value of each of the fourth reference signals into the strength value of the self-interference signal to generate a plurality of fifth reference signals; and determining by the signal determiner a difference between each of the fifth reference signals and the receiving signal, and determining one of the fifth reference signals that corresponds to the smallest of the differences as the self-interference cancellation signal for canceling the self-interference signal.

In some embodiments, the method 5 of generating a self-interference cancellation signal may be applied to the device 91 of generating a self-interference cancellation signal in the transceiver 1. Corresponding steps of the method 5 of generating a self-interference cancellation signal for accomplishing those operations shall be readily appreciated by those of ordinary skill in the art based on the above description of the device 91 of generating a self-interference cancellation signal, and thus will not be further described herein.

According to the above descriptions, different from the conventional analog interference cancellation technology, the present invention neither needs to use the iteration algorithms nor needs to convert the self-interference signal from the radio frequency to the base frequency during the process of generating the self-interference cancellation signal. Therefore, the present invention can effectively reduce the computation amount and the computation complexity of the conventional analog interference cancellation technology.

The above disclosure is related to the detailed technical contents and inventive features thereof. People skilled in this field may proceed with a variety of modifications and replacements based on the disclosures and suggestions of the invention as described without departing from the characteristics thereof. Although such modifications and replacements are not fully disclosed in the above descriptions, they have substantially been covered in the following claims as appended.

What is claimed is:

1. A device of generating a self-interference cancellation signal for a full-duplex communication device, comprising:
a strength detector, being configured to detect a strength value of a self-interference signal, the self-interference signal being from a transmitting signal of the full-duplex communication device;
a strength adjuster, being configured to adjust a strength value of a first reference signal into the strength value of the self-interference signal to generate a second reference signal;
a phase angle adjuster, being configured to adjust the second reference signal according to a predetermined adjustment parameter corresponding to each of a circle of phase angle values respectively to generate a plurality of third reference signals; and
a signal determiner, being configured to determine a difference between each of the third reference signals and a receiving signal of the full-duplex communication device, and determine one of the third reference signals that corresponds to the smallest of the differences as a self-interference cancellation signal for canceling the self-interference signal, the receiving signal comprising the self-interference signal.

2. The device of generating a self-interference cancellation signal according to claim 1, wherein the first reference signal is coupled from the transmitting signal.

3. The device of generating a self-interference cancellation signal according to claim 1, wherein the phase angle adjuster adjusts the second reference signal according to at least one of a sequence searching method and a binary searching method, and the signal determiner determines the differences according to at least one of the sequence searching method and the binary searching method.

4. The device of generating a self-interference cancellation signal according to claim 1, wherein the phase angle adjuster comprises a multi-path adjustment circuit, the multi-path adjustment circuit comprises multiple paths each of which comprises a delay element and an attenuation/gain element, and the phase angle adjuster determines the circle of phase angle values and the predetermined adjustment parameters by controlling the delay elements and the attenuation/gain elements.

5. The device of generating a self-interference cancellation signal according to claim 4, wherein the phase angle adjuster controls the delay elements and the attenuation/gain elements according to each of the predetermined adjustment parameters respectively to adjust the second reference signal.

6. The device of generating a self-interference cancellation signal according to claim 1, wherein the phase angle adjustor comprises a single-path adjustment circuit, the single-path adjustment circuit comprises a delay element and an attenuation/gain element, and the phase angle adjuster determines the circle of phase angle values and the predetermined adjustment parameters by controlling the single delay element and the single attenuation/gain element.

7. The device of generating a self-interference cancellation signal according to claim 6, wherein the phase angle adjuster controls the delay element and the attenuation/gain element according to each of the predetermined adjustment parameters respectively to adjust the second reference signal.

8. The device of generating a self-interference cancellation signal according to claim 1, wherein:
the phase angle adjuster is further configured to adjust the first reference signal according to the predetermined adjustment parameter corresponding to each of the circle of phase angle values respectively to generate a plurality of fourth reference signals;
the strength adjuster is further configured to adjust a strength value of each of the fourth reference signals into the strength value of the self-interference signal to generate a plurality of fifth reference signals; and
the signal determiner is further configured to determine a difference between each of the fifth reference signals and the receiving signal, and determine one of the fifth reference signals that corresponds to the smallest of the differences as the self-interference cancellation signal for canceling the self-interference signal.

9. A method of generating a self-interference cancellation signal for a full-duplex communication device, the method comprising:
detecting by a strength detector a strength value of a self-interference signal, the self-interference signal being from a transmitting signal of the full-duplex communication device;
adjusting by a strength adjuster a strength value of a first reference signal into the strength value of the self-interference signal to generate a second reference signal;
adjusting by a phase angle adjuster the second reference signal according to a predetermined adjustment parameter corresponding to each of a circle of phase angle values respectively to generate a plurality of third reference signals;
determining by a signal determiner a difference between each of the third reference signals and a receiving signal of the full-duplex communication device, the receiving signal comprising the self-interference signal; and
determining by the signal determiner one of the third reference signals that corresponds to the smallest of the differences as a self-interference cancellation signal for canceling the self-interference signal.

10. The method of generating a self-interference cancellation signal according to claim 9, wherein the first reference signal is coupled from the transmitting signal.

11. The method of generating a self-interference cancellation signal according to claim 9, wherein the phase angle adjuster adjusts the second reference signal according to at least one of a sequence searching method and a binary searching method, and the signal determiner determines the differences according to at least one of the sequence searching method and the binary searching method.

12. The method of generating a self-interference cancellation signal according to claim 9, wherein the phase angle adjuster comprises a multi-path adjustment circuit, the multi-path adjustment circuit comprises multiple paths each of which comprises a delay element and an attenuation/gain element, and the phase angle adjuster determines the circle of phase angle values and the predetermined adjustment parameters by controlling the delay elements and the attenuation/gain elements.

13. The method of generating a self-interference cancellation signal according to claim 12, wherein the phase angle adjuster controls the delay elements and the attenuation/gain elements according to each of the predetermined adjustment parameters respectively to adjust the second reference signal.

14. The method of generating a self-interference cancellation signal according to claim 9, wherein the phase angle adjustor comprises a single-path adjustment circuit, the single-path adjustment circuit comprises a delay element and an attenuation/gain element, and the phase angle adjuster determines the circle of phase angle values and the predetermined adjustment parameters by controlling the single delay element and the single attenuation/gain element.

15. The method of generating a self-interference cancellation signal according to claim 14, wherein the phase angle adjuster controls the delay element and the attenuation/gain element according to each of the predetermined adjustment parameters respectively to adjust the second reference signal.

16. The method of generating a self-interference cancellation signal according to claim 9, further comprising:
adjusting by the phase angle adjuster the first reference signal according to the predetermined adjustment parameter corresponding to each of the circle of phase angle values respectively to generate a plurality of fourth reference signals;
adjusting by the strength adjuster a strength value of each of the fourth reference signals into the strength value of the self-interference signal to generate a plurality of fifth reference signals; and
determining by the signal determiner a difference between each of the fifth reference signals and the receiving signal, and determining one of the fifth reference signals that corresponds to the smallest of the differences as the self-interference cancellation signal for canceling the self-interference signal.
